(19) United States
(12) Patent Application Publication
(10) Pub. No.: US 2025/0030346 A1
(43) Pub. Date: Jan. 23, 2025

(54) POWER SUPPLY CONTROLLER AND SWITCHING POWER SUPPLY

(71) Applicant: ROHM CO., LTD., Kyoto (JP)

(72) Inventor: Yukihiro WATANABE, Kyoto (JP)

(21) Appl. No.: 18/750,055

(22) Filed: Jun. 21, 2024

(30) Foreign Application Priority Data
Jul. 20, 2023 (JP) 2023-118094

(51) Int. Cl. H02M 3/158

(52) U.S. Cl. CPC H02M 3/1588

(57) ABSTRACT

A power supply controller provided in a switching power supply which generates output voltage from input voltage and configured to control operation of the switching power supply includes: an output stage including an output element between an application terminal for the input voltage and a switch terminal, and a rectifier element between the switch terminal and a reference potential terminal; a control circuit to generate control signal according to the output voltage; and an output element drive circuit to turn on or off the output element according to the control signal by drive voltage for turning on the output element, wherein when switching the output element from an off state to an on state, the output element drive circuit switches the output element from the off state to the on state by the drive voltage having first voltage and increases the drive voltage to second voltage.

### CROSS-REFERENCE TO RELATED APPLICATION

This application is based upon and claims the benefit of priority from Japanese Patent Application No. 2023-118094, filed on Jul. 20, 2023, the entire contents of which are incorporated herein by reference.

### TECHNICAL FIELD

The present disclosure relates to a power supply controller and a switching power supply.

### BACKGROUND

In a switching power supply, a so-called bootstrap circuit is often used to form a boost power supply for driving an output element.

### BRIEF DESCRIPTION OF DRAWINGS

The accompanying drawings, which are incorporated in and constitute a part of the specification, illustrate embodiments of the present disclosure.

FIG. 1 is an overall configuration diagram of a switching power supply according to an embodiment of the present disclosure.

FIG. 2 is an external perspective view of a power supply controller according to an embodiment of the present disclosure.

FIG. 3 is a waveform diagram of a gate signal for an output transistor and a delay signal based on the gate signal, according to an embodiment of the present disclosure.

FIG. 4 is a timing chart of the switching power supply according to an embodiment of the present disclosure.

FIG. 5 is an overall configuration diagram of a switching power supply according to a reference example.

FIG. 6 is a waveform diagram related to the switching power supply shown in FIG. 5.

FIG. 7 is a waveform diagram related to the switching power supply shown in FIG. 1.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

Examples of embodiments of the present disclosure will be specifically described below with reference to the drawings. In the respective figures referred to, the same parts are designated by like reference numerals, and duplicate descriptions regarding the same parts will be omitted in principle. In the present disclosure, for the purpose of simplifying the descriptions, by indicating symbols or codes that refer to information, signals, physical quantities, functional parts, circuits, elements, components, or the like, names of the information, signals, physical quantities, functional parts, circuits, elements, components, or the like corresponding to the symbols or the codes may be omitted or abbreviated.

First, some terms used in description of embodiments of the present disclosure will be explained. The term “ground” refers to a reference potential end (reference conductive part) having a reference potential of 0 V (zero volts), or refers to the 0 V potential itself. The potential of 0 V is sometimes referred to as a ground potential. In the embodiments of the present disclosure, voltages indicated without a particular reference represent potentials as seen from the ground. The term “level” refers to a level of a potential. For any signal or voltage of interest, a high level has a higher potential than a low level. Regarding any signal of interest, when the signal is at a high level, an inverted signal thereof takes a low level, and when the signal is at a low level, an inverted signal thereof takes a high level.

Regarding an arbitrary transistor configured as a field effect transistor (FET) such as a MOSFET or the like, an expression “on state” refers to a state in which a drain and a source of a transistor are electrically connected, and an expression “off state” refers to a state (cut-off state) in which a drain and a source of a transistor are not electrically connected. The same applies to transistors that are not classified as FETs. A MOSFET is understood to be an enhancement type MOSFET unless otherwise specified. The MOSFET is an abbreviation for “metal-oxide-semiconductor field-effect transistor.” Furthermore, unless otherwise specified, it may be considered that a back gate of an arbitrary MOSFET is short-circuited to a source.

Hereinafter, an on state and an off state of an arbitrary transistor may be simply expressed as on and off. Regarding an arbitrary transistor, a period in which the transistor is in an on state is referred to as an on period, and a period in which the transistor is in an off state is referred to as an off period. Regarding an arbitrary signal having a signal level of high level or low level, a period in which a level of the signal is at a high level is referred to as a high level period, and a period in which the level of the signal is at a low level is referred to as a low level period. The same applies to an arbitrary voltage that takes a high voltage level or a low voltage level.

Connections among multiple parts forming a circuit, such as arbitrary circuit elements, wirings, nodes, etc., may be understood to refer to electrical connections, unless otherwise specified.

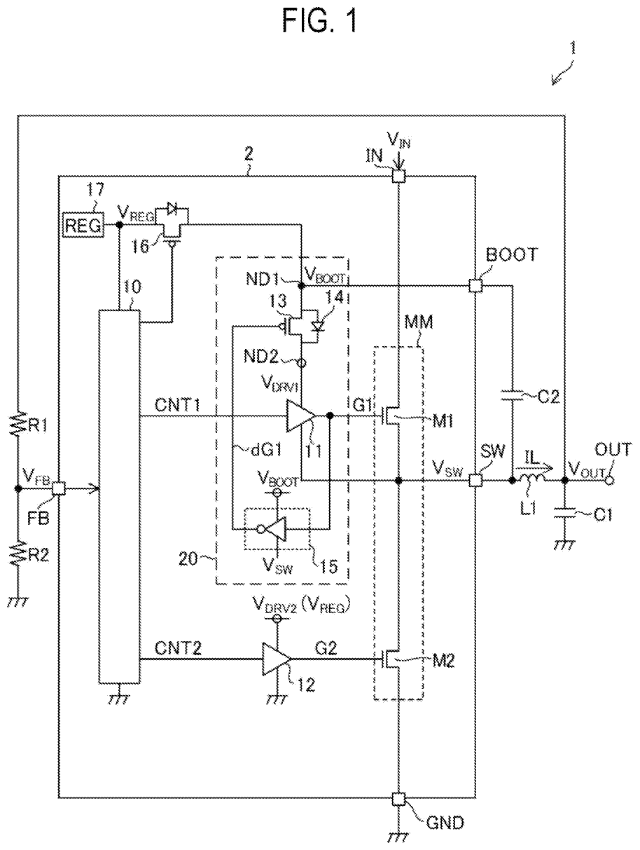

FIG. 1 is an overall configuration diagram of a switching power supply 1 according to an embodiment of the present disclosure. The switching power supply 1 includes a power supply controller 2 configured to control an operation of the switching power supply 1 and a plurality of discrete components provided outside the power supply controller 2. The discrete components include a capacitor C1 as an output capacitor, a capacitor C2 as a boot capacitor, resistors R1 and R2 as feedback resistors, and a coil L1. The switching power supply 1 is constituted as a step-down switching power supply (DC/DC converter) configured to generate a desired output voltage V_{OUT} from an input voltage V_{IN} supplied from a voltage source (not shown). The output voltage V_{OUT} is generated at an output terminal OUT. That is, the output terminal OUT is an application terminal for the output voltage V_{OUT} (a terminal to which the output voltage V_{OUT} is applied). The output voltage V_{OUT} is supplied to an arbitrary load (not shown) connected to the output terminal OUT.

The input voltage V_{IN} and the output voltage V_{OUT} are positive DC voltages, and the output voltage V_{OUT} is lower than the input voltage V_{IN}. For example, when the input voltage V_{IN} is 12 V, the output voltage V_{OUT} can be stabilized at a desired target voltage V_{TG} (e.g., 5 V) below 12 V by adjusting resistance values of the resistors R1 and R2.

The switching power supply 1 may be mounted on a vehicle such as an automobile, for example. In this case, the input voltage V_{IN} may be an output voltage of a battery mounted on a vehicle. In addition, the switching power supply 1 may be provided in an arbitrary device (e.g., a smartphone, a portable information terminal, a computer device, a game device, a television device, or an air conditioner).

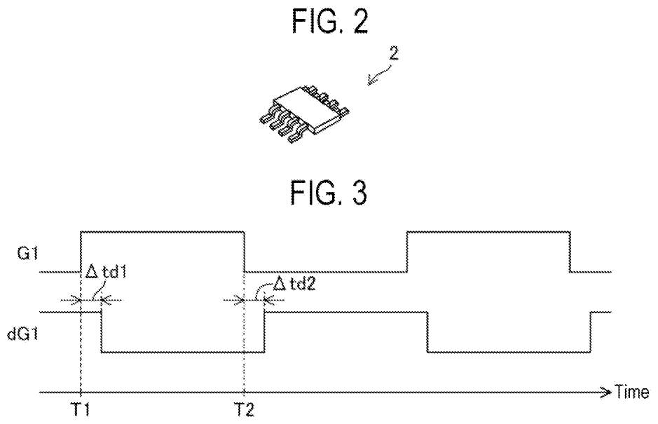

FIG. 2 is an external perspective view of the power supply controller 2. The power supply controller 2 is an electronic component (semiconductor device) that includes a semiconductor chip including a semiconductor integrated circuit formed on a semiconductor substrate, a housing (package) configured to accommodate the semiconductor chip, and a plurality of external terminals exposed to an outside of the power supply controller 2 from the housing. The power supply controller 2 is formed by sealing the semiconductor chip in the housing (package) made of a resin. The number of external terminals of the power supply controller 2 and a type of the housing of the power supply controller 2 shown in FIG. 2 are merely examples, and may be designed arbitrarily. The respective parts designated by reference numerals 11 to 17 in FIG. 1 are included in the semiconductor integrated circuit.

In FIG. 1, only an input terminal IN, a switch terminal SW, a ground terminal GND, a boot terminal BOOT, and a feedback terminal FB are shown as the plurality of external terminals provided in the power supply controller 2. However, other external terminals (e.g., an enable terminal and a power good terminal) may also be provided in the power supply controller 2.

An external configuration of the power supply controller 2 will be described. An input voltage V_{IN} is supplied from the outside of the power supply controller 2 to the input terminal IN. A coil L1 is interposed in series between the switch terminal SW and the output terminal OUT. That is, a first end of the coil L1 is connected to the switch terminal SW, and a second end of the coil L1 is connected to the output terminal OUT. Further, the output terminal OUT is connected to the ground via a capacitor C1. That is, a first end of the capacitor C1 is connected to the output terminal OUT, and a second end of the capacitor C1 is connected to the ground. A current flowing through the coil L1 is referred to as a coil current IL.

A capacitor C2 is provided between the terminals BOOT and SW. That is, a first end of the capacitor C2 is connected to the boot terminal BOOT, and a second end of the capacitor C2 is connected to the switch terminal SW. A ground terminal GND is connected to the ground.

Further, the output terminal OUT is connected to a first end of the resistor R1, and a second end of the resistor R1 is connected to the ground via the resistor R2. A connection node between the resistors R1 and R2 is connected to the feedback terminal FB. A feedback voltage V_{FB} according to the output voltage V_{OUT} is generated at the connection node between the resistors R1 and R2. The feedback voltage V_{FB} is a partial voltage of the output voltage V_{OUT} and is therefore proportional to the output voltage V_{OUT}. A feedback voltage generation circuit configured to generate the feedback voltage V_{FB} is constituted by the resistors R1 and R2. The feedback terminal FB of the power supply controller 2 is connected to the connection node between the resistors R1 and R2 to receive the feedback voltage V_{FB}. The output voltage V_{OUT} itself may be used as the feedback voltage V_{FB}. In any case, the feedback voltage V_{FB} is a voltage according to the output voltage V_{OUT}.

An internal configuration of the power supply controller 2 will be described. The power supply controller 2 includes an output stage MM, a control circuit 10, a high side driver 11, a low side driver 12, an insertion transistor 13, a diode 14, a delay circuit 15, a boot rectifier element 16, and an internal power supply circuit 17. An output transistor drive circuit 20 (output element drive circuit) is constituted by the high side driver 11, the insertion transistor 13, the diode 14, and the delay circuit 15.

The internal power supply circuit 17 generates one or more internal power supply voltages including an internal power supply voltage V_{REG} based on the input voltage V_{IN}. The internal power supply voltage V_{REG} has a predetermined positive DC voltage value (e.g., 5 V).

The output stage MM includes transistors M1 and M2. The transistors M1 and M2 are N-channel MOSFETs. The transistors M1 and M2 are a pair of switching elements connected in series between the input terminal IN and the ground terminal GND (in other words, the ground). When the transistors M1 and M2 are switched, the input voltage V_{IN} is switched such that a rectangular wave-like switch voltage V_{SW} (switching voltage) appears at the switch terminal SW. The transistor M1 is a high side transistor provided on the high side, and the transistor M2 is a low side transistor provided on the low side. Specifically, a drain of the transistor M1 is connected to the input terminal IN, which is an application terminal of the input voltage V_{IN}, to receive the input voltage V_{IN}. A source of the transistor M1 and the drain of the transistor M2 are commonly connected to the switch terminal SW. A source of the transistor M2 is connected to the ground terminal GND. A current detection resistor (sense resistor) may be inserted between the source of the transistor M2 and the ground.

The transistor M1 functions as an output element, and the transistor M2 functions as a synchronous rectifier element. The transistor M1 may be referred to as an output transistor, and the transistor M2 may be referred to as a synchronous rectification transistor. The output stage MM is switching-controlled by the control circuit 10. In the switching control of the output stage MM, the output element (M1) and the rectifier element (M2) are alternately turned on and off. The coil L1 and the capacitor C1 constitute a rectifying and smoothing circuit configured to rectify and smooth the rectangular wave-like switch voltage V_{SW} appearing at the switch terminal SW. An output voltage V_{OUT} is generated at the output terminal OUT by the rectifying and smoothing operation. At least one selected from the group of the output element (M1) and the rectifier element (M2) may be provided outside the power supply controller 2. The entire output stage MM may be provided outside the power supply controller 2.

Gate signals G1 and G2 are supplied to gates of the transistors M1 and M2, respectively. The transistors M1 and M2 are turned on and off in response to the gate signals G1 and G2. When a gate signal G1 has a high level, the transistor M1 is turned on, and when the gate signal G1 has a low level, the transistor M1 is turned off. Similarly, when a gate signal G2 has a high level, the transistor M2 is turned on, and when the gate signal G2 has a low level, the transistor M2 is turned off. Basically, the transistors M1 and M2 are turned on and off alternately, but both of the transistors M1 and M2 may be turned off. That is, the state of the output stage MM is one of an output high state, an output low state, and a Hi-Z state. In the output high state, the transistors M1 and M2 are turned on and off, respectively. In the output low state, the transistors M1 and M2 are turned off and on, respectively. In the Hi-Z state, both of the transistors M1 and M2 are turned off. The transistors M1 and M2 are never turned on simultaneously.

In the example of FIG. 1, the boot rectifier element 16 is a P-channel MOSFET. An internal power supply voltage V_{REG} is supplied to a drain of the MOSFET as the boot rectifier element 16, and a source of the MOSFET as the boot rectifier element 16 is connected to a node ND1. The node ND1 is connected to the boot terminal BOOT. A bootstrap circuit is constituted by the boot rectifier element 16 and the capacitor C2. The voltage at the boot terminal BOOT and the node ND1 is referred to as a boot voltage V_{BOOT}. FIG. 1 shows a parasitic diode accompanying the MOSFET as the boot rectifier element 16. The parasitic diode has a forward direction from an application terminal of the internal power supply voltage V_{REG} toward the node ND1.

When the output stage MM is in the output low state, the boot rectifier element 16 is controlled to be turned on by the control circuit 10, and the capacitor C2 is charged through the boot rectifier element 16 based on the internal power supply voltage V_{REG}. The boot voltage V_{BOOT} is higher than the switch voltage V_{SW} by the voltage across the capacitor C2. When the output stage MM is in the output high state, the boot rectifier element 16 is controlled to be turned off by the control circuit 10. Even when the output stage MM is brought into the output high state, the boot voltage V_{BOOT} is maintained higher than the switch voltage V_{SW} by the voltage across the capacitor C2.

Similar to the ND1, the node ND2 is an internal node provided within the power supply controller 2. The insertion transistor 13 is a switch provided between the nodes ND1 and ND2. The insertion transistor 13 connects or disconnects the nodes ND1 and ND2 depending on a signal supplied to a gate of the insertion transistor 13. The insertion transistor 13 is constituted by a P-channel MOSFET. A drain of the insertion transistor 13 is connected to the node ND1, and a source of the insertion transistor 13 is connected to the node ND2. The diode 14 is added in parallel to the insertion transistor 13. The diode 14 has a forward direction from the node ND1 to the node ND2. That is, an anode of the diode 14 is connected to the node ND1, and a cathode of the diode 14 is connected to the node ND2. Herein, it is assumed that the diode 14 is a parasitic diode accompanying the insertion transistor 13. However, the diode 14 may be a diode provided separately from the insertion transistor 13 (that is, the diode 14 may be a diode different from the parasitic diode of the insertion transistor 13). The voltage at the node ND2 is referred to as a drive voltage V_{DRV1}.

The control circuit 10 is driven based on the internal power supply voltage V_{REG} with the ground potential used as a reference. The control circuit 10 is connected to the feedback terminal FB to receive the feedback voltage V_{FB}. The control circuit 10 generates control signals CNT1 and CNT2 according to the feedback voltage V_{FB}. The control signals CNT1 and CNT2 are binary signals having a high level or a low level. The high level of the control signals CNT1 and CNT2 has the potential of the internal power supply voltage V_{REG}, and the low level of the control signals CNT1 and CNT2 has the ground potential.

The control signals CNT1 at the high level and the low level are signals for instructing to set the transistor M1 to an on state and an off state, respectively. The control signals CNT2 at the high level and the low level are signals for instructing to set the transistor M2 to an on state and an off state, respectively. The control signals CNT1 and CNT2 are rectangular wave signals having a predetermined PWM frequency. The PWM frequency corresponds to a switching period of the output stage MM. During a high level period of the control signal CNT1, the control signal CNT2 always has a low level, and during a high level period of the control signal CNT2, the control signal CNT1 always has a low level.

The control circuit 10 generates the control signals CNT1 and CNT2 based on a difference between the feedback voltage V_{FB} and a predetermined reference voltage by using pulse width modulation or the like so as to reduce the difference. The control circuit 10 may include a sense circuit configured to detect the coil current IL, and may also generate the control signals CNT1 and CNT2 by referring to a detection result of the coil current IL (so-called a current mode control may also be performed). The control signal CNT1 is supplied to the high side driver 11, and the control signal CNT2 is supplied to the low side driver 12.

Further, the control circuit 10 sets the boot rectifier element 16 to an on state or an off state by controlling a gate potential of the boot rectifier element 16. The control circuit 10 controls the gate potential of the boot rectifier element 16 so that the boot rectifier element 16 is turned on during the high level period of the control signal CNT2 (in other words, so that the boot rectifier element 16 is turned on during a low level period of the control signal CNT1), and so that the boot rectifier element 16 is turned off during a low level period of the control signal CNT2 (in other words, so that the boot rectifier element 16 is turned off during the high level period of the control signal CNT1).

The high side driver 11 is connected to the gate of the transistor M1. The high side driver 11 turns on or off the transistor M1 by supplying the gate signal G1 to the gate of the transistor M1 according to the control signal CNT1. The high side driver 11 is connected to the node ND2 and the switch terminal SW and is driven by using the drive voltage V_{DRV1} at the node ND2 as a positive power supply voltage and using the switch voltage V_{SW} at the switch terminal SW as a negative power supply voltage. The drive voltage V_{DRV1} functions as a voltage for turning on the transistor M1.

The gate signal G1 has a high level potential or a low level potential. The high side driver 11 generates the gate signal G1 so that the gate signal G1 has a high level during the high level period of the control signal CNT1, and so that the gate signal G1 has a low level during the low level period of the control signal CNT1. The high side driver 11 includes a level shifter configured to shift the level of the control signal CNT1 to the level of the gate signal G1.

The high level of the gate signal G1 has a potential corresponding to the drive voltage V_{DRV1}, and is substantially equal to the potential of the drive voltage V_{DRV1}. Strictly speaking, the gate signal G1 at the high level may be lower than the drive voltage V_{DRV1} by a very small voltage. Hereinafter, it is assumed that the gate signal G1 at the high level has the potential of the drive voltage V_{DRV1}. The potential of the gate signal G1 at the high level increases as the drive voltage V_{DRV1} increases, and decreases as the drive voltage V_{DRV1} decreases. The low level of the gate signal G1 has a potential corresponding to the switch voltage V_{SW}, and is substantially equal to the potential of the switch voltage V_{SW}. Strictly speaking, the gate signal G1 at the low level may be higher than the switch voltage V_{SW} by a very small voltage. Hereinafter, it is assumed that the gate signal G1 at the low level has the potential of the switch voltage V_{SW}.

When switching control is executed, a value of the internal power supply voltage V_{REG} is set so that a differential voltage (V_{DRV1}−V_{SW}) is higher than a gate threshold voltage of the transistor M1 even when the insertion transistor 13 is turned off. Therefore, the transistor M1 is turned on during a high level period of the gate signal G1. During a low level period of the gate signal G1, a gate-source voltage of the transistor M1 is substantially 0 V (lower than at least the gate threshold voltage of the transistor M1). Therefore, the transistor M1 is turned off.

The low side driver 12 is connected to the gate of the transistor M2. The low side driver 12 turns on or off the transistor M2 by supplying the gate signal G2 to the gate of the transistor M2 according to the control signal CNT2. The low side driver 12 is connected to an application terminal of a drive voltage V_{DRV2} and the ground and is driven by using the drive voltage V_{DRV2} as a positive power supply voltage and using the ground voltage as a negative power supply voltage. The drive voltage V_{DRV2} is an internal power supply voltage generated by the internal power supply circuit 17, and has a positive DC voltage value. The drive voltage V_{DRV2} is higher than a gate threshold voltage of the transistor M2. Although the internal power supply voltage V_{REG} is used as the drive voltage V_{DRV2}, the drive voltage V_{DRV2} may be a DC voltage different from the internal power supply voltage V_{REG}. The drive voltage V_{DRV2} functions as a voltage for turning on the transistor M2.

The gate signal G2 has a high level potential or a low level potential. The low side driver 12 generates the gate signal G2 so that the gate signal G2 has a high level during the high level period of the control signal CNT2, and so that the gate signal G2 has a low level during the low level period of the control signal CNT2.

The high level of the gate signal G2 has a potential corresponding to the drive voltage V_{DRV2}, and is substantially equal to the potential of the drive voltage V_{DRV2}. Strictly speaking, the gate signal G2 at the high level may be lower than the drive voltage V_{DRV2} by a minute voltage. Hereinafter, it is assumed that the gate signal G2 at the high level has the potential of the drive voltage V_{DRV2}. The low level of the gate signal G2 is substantially equal to the ground potential. Strictly speaking, the gate signal G2 at the low level may be higher than the ground potential by a minute voltage. Hereinafter, it is assumed that the gate signal G2 at the low level has the ground potential.

Since the drive voltage V_{DRV2} is higher than the gate threshold voltage of the transistor M2, the transistor M2 is turned on during a high level period of the gate signal G2. During a low level period of the gate signal G2, a gate-source voltage of the transistor M2 is substantially equal to 0 V (lower than at least the gate threshold voltage of the transistor M2). Therefore, the transistor M2 is turned off.

A delay circuit 15 is provided between the gate of the transistor M1 and the gate of insertion transistor 13. The delay circuit 15 is connected to the gate of the transistor M1 and the gate of the insertion transistor 13. The delay circuit 15 supplies a delay signal dG1 to the gate of the insertion transistor 13 based on the gate signal G1. The delay circuit 15 generates and outputs a signal obtained by delaying the gate signal G1 as a delay signal dG1. At this time, the delay circuit 15 generates and outputs an inverted signal of the gate signal G1 as the delay signal dG1. Therefore, the delayed signal dG1 may be referred to as an inverted delay signal dG1.

FIG. 3 shows a relationship between the gate signal G1 and the delay signal dG1. In principle, the delay circuit 15 uses the delay signal dG1 as an inverted signal of the gate signal G1. However, when the gate signal G1 is switched from a low level to a high level at time T1, the delay circuit 15 switches the delay signal dG1 from a high level to a low level at the time when a predetermined delay time Δtd1 has elapsed from time T1. Thereafter, when the gate signal G1 is switched from a high level to a low level at time T2, the delay circuit 15 switches the delay signal dG1 from a low level to a high level at the time when a predetermined delay time Δtd2 has elapsed from time T2. The delay times Δtd1 and Δtd2 are sufficiently shorter than ½ of the switching period of the output stage MM (i.e., ½ of a reciprocal of the PWM frequency). The delay times Δtd1 and Δtd2 may be the same as or different from each other. It is not essential to provide the delay time Δtd2. During the high level period of the gate signal G1, the level of the gate signal G1 actually fluctuates as the drive voltage V_{DRV1} fluctuates. However, illustration of the fluctuation is omitted in FIG. 3.

The insertion transistor 13 is turned on or off according to the delay signal dG1. When the delay signal dG1 has a high level, the insertion transistor 13 is turned off, and when the delay signal dG1 has a low level, the insertion transistor 13 is turned on. Therefore, after the transistor M1 is switched from an off state to an on state by switching the gate signal G1 of the transistor M1 from a low level to a high level, the insertion transistor 13 is switched from an off state to an on state.

The delay circuit 15 is driven by using the boot voltage V_{BOOT} at the node ND1 as a positive power supply voltage and using the switch voltage V_{SW} at the switch terminal SW as a negative power supply voltage. Therefore, the delay signal dG1 at the high level has the potential of the boot voltage V_{BOOT}, and the delay signal dG1 at the low level has the potential of the switch voltage V_{SW}. As a modification, the negative power supply voltage in the delay circuit 15 may be a voltage lower than the switch voltage V_{SW} (e.g., the ground voltage). In this case, the delay signal dG1 at the low level has a lower potential than the switch voltage V_{SW} (e.g., the ground potential). The delay circuit 15 is constituted by a single inverter circuit or by a plurality of series-connected delay elements including an inverter circuit.

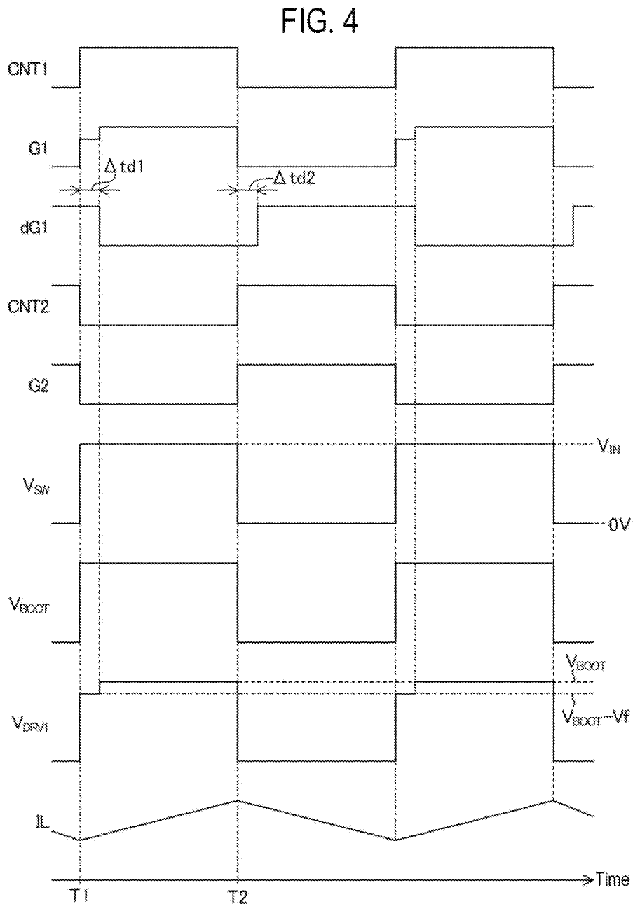

FIG. 4 is a timing chart of the switching power supply 1. In FIG. 4, from the top to the bottom, waveforms of the control signal CNT1, the gate signal G1, the delay signal dG1, the control signal CNT2, the gate signal G2, the switch voltage V_{SW}, the boot voltage V_{BOOT}, the drive voltage V_{DRV1}, and the coil current IL are shown. The timing chart shown in FIG. 4 is a timing chart for a period in which switching control is performed in a continuous current mode. In the continuous current mode, the coil current IL always flows from the switch terminal SW to the output terminal OUT. It is assumed that on-resistances of the transistors M1 and M2 are sufficiently small. For the sake of simplicity, it is assumed that a voltage between the drain and the source of the transistor M1 during an on-period of the transistor M1 and a voltage between the drain and the source of the transistor M2 during an on-period of the transistor M2 are zero. Further, when switching the output stage MM between the output high state and the output low state, a dead time period in which the transistors M1 and M2 are turned off simultaneously may be inserted to suppress a through current. Herein, existence of the dead time period is ignored.

During a switching control execution period, the level of the control signal CNT1 is alternately switched between a low level and a high level. A time when the level of the control signal CNT1 is switched from the low level to the high level is time T1. Time T2 is a time when the level of the control signal CNT1 is switched from the high level to the low level after time T1.

At time T1, the control circuit 10 switches the level of the control signal CNT1 from the low level to the high level, and also switches the level of the control signal CNT2 from the high level to the low level. As a result, at time T1, the state of the transistor M1 is switched from the off state to the on state, and the state of the transistor M2 is switched from the on state to the off state through transition of the gate signal G1 to the high level and transition of the gate signal G2 to the low level. As a result, the switch voltage V_{SW} rises sharply from a level of 0 V to a level of the input voltage V_{IN}, and the boot voltage V_{BOOT} also rises by the amount of the rise in the switch voltage V_{SW}.

The drive voltage V_{DRV1} also rises in conjunction with the rise in the boot voltage V_{BOOT}. However, since the delay signal dG1 is at a high level until the delay time Δtd1 has elapsed from time T1, the insertion transistor 13 is turned off. Therefore, the drive voltage V_{DRV1} is lower than the boot voltage V_{BOOT} by a forward voltage Vf of the diode 14 until the delay time Δtd1 has elapsed from time T1.

A time later than time T1 by the delay time Δtd1 is earlier than time T2. At the time later than time T1 by the delay time Δtd1, the delay signal dG1 is changed from the high level to the low level. Therefore, the state of the insertion transistor 13 is switched from an off state to an on state. As a result, the drive voltage V_{DRV1} quickly rises to the level of the boot voltage V_{BOOT}.

Thereafter, at time T2, the control circuit 10 switches the level of the control signal CNT1 from a high level to a low level, and also switches the level of the control signal CNT2 from a low level to a high level. As a result, the state of the transistor M1 is switched from the on state to the off state, and the state of the transistor M2 is switched from the off state to the on state, through transition of the gate signal G1 to the low level and transition of the gate signal G2 to the high level. As a result, the switch voltage V_{SW} drops sharply from the level of the input voltage V_{IN} to the level of 0 V, and the boot voltage V_{BOOT} also drops by the amount of the drop in the switch voltage V_{SW}.

The drive voltage V_{DRV1} also drops in conjunction with the drop in the boot voltage V_{BOOT}. At time T2, the insertion transistor 13 is turned on based on the delay signal dG1 at the low level. Therefore, in conjunction with the drop in the boot voltage V_{BOOT}, the drive voltage V_{DRV1} also quickly drops by approximately the amount of drop in the boot voltage V_{BOOT}. Thereafter, the same operation is repeated.

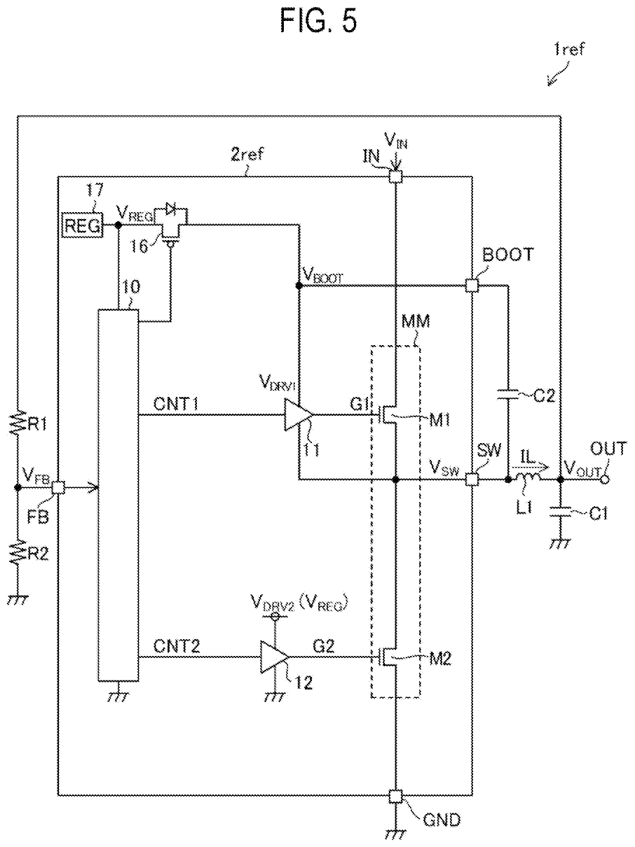

FIG. 5 shows a switching power supply 1ref according to a reference example, which is provided for comparison with the switching power supply 1. The switching power supply 1ref includes a power supply controller 2ref instead of the power supply controller 2. The power supply controller 2ref is not provided with the insertion transistor 13, the diode 14, and the delay circuit 15. In the power supply controller 2ref, “V_{DRV1}=V_{BOOT}” at all times.

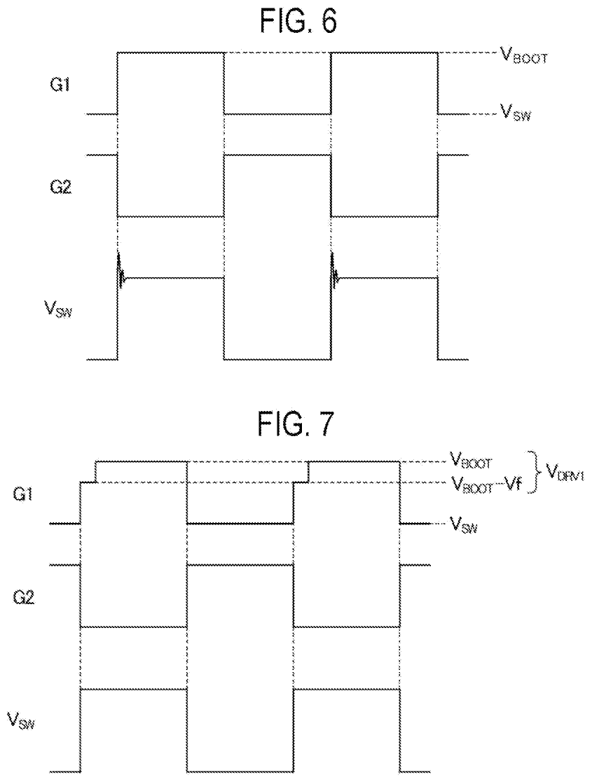

FIG. 6 shows waveforms of the gate signals G1 and G2 and the switch voltage V_{SW} in the switching power supply 1ref. In the switching power supply 1ref, the gate signal G1 sharply rises from the level of the switch voltage V_{SW} to the level of the boot voltage V_{BOOT} in response to the transition of the control signal CNT1 to the high level. As a result, in the switching power supply 1ref, ringing occurs in the switch voltage V_{SW} due to an inductance component of a wiring or a conductor connected to the output stage MM or related parts. The ringing of the switch voltage V_{SW} causes a reduction in noise characteristics and power supply efficiency. In the switching power supply 1ref, if the boot voltage V_{BOOT} is lowered (if a voltage across the capacitor C2 is lowered), the ringing of the switch voltage V_{SW} is suppressed. However, when the boot voltage V_{BOOT} is lowered, the power supply efficiency is lowered due to the increase in the on-resistance of the transistor M1.

FIG. 7 shows waveforms of the gate signals G1 and G2 and the switch voltage V_{SW} in the switching power supply 1. In the switching power supply 1, the gate signal G1 first rises from the level of the switch voltage V_{SW} to the level of a voltage (V_{BOOT}−Vf) in response to the transition of the control signal CNT1 to the high level. By suppressing the rise in the gate signal G1 to the level of the voltage (V_{BOOT}−Vf), the switch voltage V_{SW} rises more smoothly than in the switching power supply ref, and the ringing in the switch voltage V_{SW} is suppressed. In the switching power supply 1, the insertion transistor 13 is then turned on, such that the gate signal G1 rises to the level of the boot voltage V_{BOOT}. By increasing the gate signal G1, the on-resistance of the transistor M1 can be lowered, thereby suppressing a decrease in the power supply efficiency. That is, according to the switching power supply 1, the noise characteristics can be improved while suppressing a decrease in the power supply efficiency.

As described above, in the switching power supply 1, when switching the transistor M1 from the off state to the on state based on the control signal CNT1, the output transistor drive circuit 20 switches the transistor M1 from the off state to the on state by using the drive voltage V_{DRV1} having the first voltage, and then increasing the drive voltage V_{DRV1} to the second voltage.

Herein, the first voltage corresponds to the drive voltage V_{DRV1} (=V_{BOOT}−Vf) when the insertion transistor 13 is turned off, and the second voltage corresponds to the drive voltage V_{DRV1} (=V_{BOOT}) when the insertion transistor 13 is turned on. In other words, when switching the transistor M1 from the off state to the on state based on the control signal CNT1, the output transistor drive circuit 20 switches the transistor M1 from the off state to the on state by using the drive voltage V_{DRV1} (=V_{BOOT}−Vf) when the insertion transistor 13 is turned off, and then keeps the transistor M1 in the on state by using the drive voltage V_{DRV1} (=V_{BOOT}) when the insertion transistor 13 is turned on.

It can be said that the output transistor drive circuit 20 includes an output element driver and a drive voltage generation circuit. The output element driver corresponds to the high side driver 11. The output element driver is connected to the node ND2 and the switch terminal SW to supply a gate signal G1 at the high level corresponding to the drive voltage V_{DRV1} or a gate signal G1 at the low level corresponding to the switch voltage V_{SW} to the gate of the transistor M1 based on the control signal CNT1. The drive voltage generation circuit includes the insertion transistor 13 (switch), the diode 14, and the delay circuit 15, and generates the drive voltage V_{DRV1} from the second voltage (V_{BOOT}).

### Modification, Etc

Modification techniques, application techniques, supplementary matters, etc. for the above-described switching power supply 1 will be described.

A diode rectification method may be adopted in the output stage MM. When the diode rectification method is adopted, a synchronous rectification diode having an anode connected to the ground terminal GND and a cathode connected to the switch terminal SW is used as a rectification element instead of the transistor M2. When the diode rectification method is adopted, the low side driver 12 is not necessary, and therefore the generation of the control signal CNT2 is also not necessary. When the diode rectification method is adopted, only the output element (M1) is turned on or off in the switching control of the output stage MM. When the diode rectification method is adopted, the control circuit 10 may control the gate potential of the boot rectifier element 16 so that the boot rectifier element 16 is turned on during the low level period of the control signal CNT1, and so that the boot rectifier element 16 is turned off during the high level period of the control signal CNT1.

In the switching power supply 1 shown in FIG. 1, a switching element is used as the boot rectifier element 16. However, the boot rectifier element 16 may be constituted by a simple rectifier diode. In this case, the rectifier diode as the boot rectifier element 16 has an anode connected to the application terminal of the internal power supply voltage V_{REG} and a cathode connected to the node ND1. When the boot rectifier element 16 is a rectifier diode, the control circuit 10 does not need to control an electrical connection of the boot rectifier element 16.

The boot rectifier element 16 may be provided outside the power supply controller 2.

For an arbitrary signal or voltage, a relationship between a high level and a low level thereof may be reversed without impairing the above-described spirit.

The types of the channels of the field effect transistors (FETs) shown in the above-described embodiments are exemplary. The channel type of an arbitrary FET may be changed between a P-channel type and an N-channel type without impairing the above-described spirit.

The arbitrary transistor mentioned above may be any type of transistor as long as no issue arises. For example, the arbitrary transistor mentioned above as a MOSFET may be replaced with a junction FET, an insulated gate bipolar transistor (IGBT), or a bipolar transistor, unless an issue arises. The arbitrary transistor has a first electrode, a second electrode, and a control electrode. In the FET, one of the first and second electrodes is a drain, the other is a source, and the control electrode is a gate. In the IGBT, one of the first and second electrodes is a collector, the other is an emitter, and the control electrode is a gate. In the bipolar transistor that does not belong to the IGBT, one of the first and second electrodes is a collector, the other is an emitter, and the control electrode is a base.

The embodiments of the present disclosure may be appropriately modified in various ways within the scope of the technical features recited in the claims. The above embodiments are merely examples of the embodiments of the present disclosure, and meanings of the terms of respective components in the present disclosure are not limited to those described in the above embodiments. The specific numerical values shown in the above-mentioned description text are merely examples, and it goes without saying that they may be changed to various numerical values.

### Supplementary Notes

Supplementary notes will be provided regarding the present disclosure for which specific configuration examples are shown in the above-described embodiments.

The power supply controller according to one aspect of the present disclosure is a power supply controller (2) provided in a switching power supply (1) configured to generate an output voltage (V_{OUT}) from an input voltage (V_{IN}), the power supply controller configured to control an operation of the switching power supply, the power supply controller including: an output stage (MM) including an output element (M1) provided between an application terminal (IN) for the input voltage and a switch terminal (SW), and a rectifier element (M2) provided between the switch terminal and a reference potential terminal; a control circuit (10) configured to generate a control signal (CNT1) according to the output voltage; and an output element drive circuit (11 and 13 to 15) configured to turn on or off the output element according to the control signal by using a drive voltage (V_{DRV1}) for turning on the output element, wherein when switching the output element from an off state to an on state based on the control signal, the output element drive circuit switches the output element from the off state to the on state by using the drive voltage having a first voltage (V_{BOOT}−Vf) and then increases the drive voltage to a second voltage (V_{BOOT}) (first configuration).

Thus, noise characteristics can be improved while suppressing a decrease in the power supply efficiency.

In the power supply controller of the first configuration, the output element drive circuit includes a switch (13) provided between a first node (ND1) having the second voltage and a second node (ND2) having the drive voltage,
a diode (14) having a forward direction from the first node to the second node is disposed in parallel to the switch,
when switching the output element from the off state to the on state based on the control signal, the output element drive circuit switches the output element from the off state to the on state by using the drive voltage when the switch is turned off and keeps the output element in the on state by using the drive voltage when the switch is turned on,
the first voltage corresponds to the drive voltage when the switch is turned off, and is lower than the second voltage by a forward voltage of the diode, and
the second voltage corresponds to the drive voltage when the switch is turned on (second configuration).

The power supply controller of the second configuration further includes a boot terminal (BOOT) configured such that a first end of a boot capacitor (C2) is connected to the boot terminal, the switch terminal is provided as a terminal configured such that a second end of the boot capacitor is connected to the terminal, the boot terminal is connected to the first node, the output element is an output transistor (13) constituted by an N-channel field effect transistor, the output transistor includes a drain and a source, which are connected to the application terminal for the input voltage and the switch terminal, respectively, and the output element drive circuit turns on the output transistor by supplying a high level gate signal corresponding to the drive voltage to a gate of the output transistor (third configuration).

In the power supply controller of the third configuration, the output element drive circuit turns off the output transistor by supplying a low level gate signal lower than the high level gate signal to the gate of the output transistor, and the output element drive circuit includes a delay circuit (15) provided between the gate of the output transistor and the switch, and switches the switch from an off state to an on state by using the delay circuit after a gate signal of the output transistor is switched from a low level to a high level (fourth configuration).

In the power supply controller of the fourth configuration, the switch is an insertion transistor which is a P-channel field effect transistor (13) configured to electrically connect or disconnect the first node and the second node according to a signal supplied to a gate of the insertion transistor, wherein the diode is a parasitic diode added to the insertion transistor or a diode provided separately from the parasitic diode, and the delay circuit supplies an inverted signal of the gate signal of the output transistor to the gate of the insertion transistor to switch the insertion transistor from an off state to an on state after the gate signal of the output transistor is switched from the low level to the high level (fifth configuration).

In the power supply controller of the fourth or fifth configuration, the output element drive circuit includes: an output element driver (11) connected to the second node and the switch terminal and configured to supply the high level gate signal corresponding to the drive voltage or the low level gate signal corresponding to a voltage of the switch terminal to the gate of the output transistor based on the control signal; and a drive voltage generation circuit (13 to 15) including the switch, the diode, and the delay circuit and configured to generate the drive voltage from the second voltage (sixth configuration).

In the power supply controller of any one of the first to sixth configuration, the output voltage is generated when a switch voltage (V_{SW}) generated at the switch terminal is rectified and smoothed by alternately turning on and off the output element based on the control signal (seventh configuration).

A switching power supply according to one aspect of the present disclosure includes: the power supply controller of any one of the first to sixth configurations; and a rectifying and smoothing circuit (L1 and C1) connected to the switch terminal and an output terminal (OUT), wherein the rectifying and smoothing circuit rectifies and smoothes a switch voltage (V_{SW}) generated at the switch terminal when the output element is alternately turned on and off based on the control signal, such that the output voltage is generated at the output terminal (eighth configuration).

While certain embodiments have been described, these embodiments have been presented by way of example only, and are not intended to limit the scope of the disclosures. Indeed, the embodiments described herein may be embodied in a variety of other forms. Furthermore, various omissions, substitutions, and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A power supply controller provided in a switching power supply configured to generate an output voltage from an input voltage, the power supply controller configured to control an operation of the switching power supply, the power supply controller comprising:
an output stage including an output element provided between an application terminal for the input voltage and a switch terminal, and a rectifier element provided between the switch terminal and a reference potential terminal;
a control circuit configured to generate a control signal according to the output voltage; and
an output element drive circuit configured to turn on or off the output element according to the control signal by using a drive voltage for turning on the output element,
wherein when switching the output element from an off state to an on state based on the control signal, the output element drive circuit switches the output element from the off state to the on state by using the drive voltage having a first voltage and then increases the drive voltage to a second voltage.

2. The power supply controller of claim 1, wherein the output element drive circuit includes a switch provided between a first node having the second voltage and a second node having the drive voltage,
wherein a diode having a forward direction from the first node to the second node is disposed in parallel to the switch,
wherein when switching the output element from the off state to the on state based on the control signal, the output element drive circuit switches the output element from the off state to the on state by using the drive voltage when the switch is turned off and keeps the output element in the on state by using the drive voltage when the switch is turned on,
wherein the first voltage corresponds to the drive voltage when the switch is turned off, and is lower than the second voltage by a forward voltage of the diode, and
wherein the second voltage corresponds to the drive voltage when the switch is turned on.

3. The power supply controller of claim 2, further comprising a boot terminal configured such that a first end of a boot capacitor is connected to the boot terminal,
wherein the switch terminal is provided as a terminal configured such that a second end of the boot capacitor is connected to the terminal,
wherein the boot terminal is connected to the first node,
wherein the output element is an output transistor constituted by an N-channel field effect transistor,
wherein the output transistor includes a drain and a source, which are connected to the application terminal for the input voltage and the switch terminal, respectively, and
wherein the output element drive circuit turns on the output transistor by supplying a high level gate signal corresponding to the drive voltage to a gate of the output transistor.

4. The power supply controller of claim 3, wherein the output element drive circuit turns off the output transistor by supplying a low level gate signal lower than the high level gate signal to the gate of the output transistor, and
wherein the output element drive circuit includes a delay circuit provided between the gate of the output transistor and the switch, and switches the switch from an off state to an on state by using the delay circuit after a gate signal of the output transistor is switched from a low level to a high level.

5. The power supply controller of claim 4, wherein the switch is an insertion transistor which is a P-channel field effect transistor configured to electrically connect or disconnect the first node and the second node according to a signal supplied to a gate of the insertion transistor,
wherein the diode is a parasitic diode added to the insertion transistor or a diode provided separately from the parasitic diode, and
wherein the delay circuit supplies an inverted signal of the gate signal of the output transistor to the gate of the insertion transistor to switch the insertion transistor from an off state to an on state after the gate signal of the output transistor is switched from the low level to the high level.

6. The power supply controller of claim 4, wherein the output element drive circuit includes:
an output element driver connected to the second node and the switch terminal and configured to supply the high level gate signal corresponding to the drive voltage or the low level gate signal corresponding to a voltage of the switch terminal to the gate of the output transistor based on the control signal; and
a drive voltage generation circuit including the switch, the diode, and the delay circuit and configured to generate the drive voltage from the second voltage.

7. The power supply controller of claim 1, wherein the output voltage is generated when a switch voltage generated at the switch terminal is rectified and smoothed by alternately turning on and off the output element based on the control signal.

8. A switching power supply, comprising:
the power supply controller of claim 1; and
a rectifying and smoothing circuit connected to the switch terminal and an output terminal,
wherein the rectifying and smoothing circuit rectifies and smoothes a switch voltage generated at the switch terminal when the output element is alternately turned on and off based on the control signal, such that the output voltage is generated at the output terminal.
